(19) United States
(12) Patent Application Publication
(10) Pub. No.: US 2014/0185123 A1
(43) Pub. Date: Jul. 3, 2014

(54) MANUFACTURING METHOD OF ELECTROCHROMIC WORKING ELECTRODE AND ELECTROCHROMIC DEVICE

(71) Applicant: BOE Technology Group Co., Ltd., Beijing (CN)

(72) Inventors: Juan CHEN, Beijing (CN); YOU- JAE- GEON, Beijing (CN); Jikai YAO, Beijing (CN); Xiaodong ZHOU, Beijing (CN)

(73) Assignee: BOE Technology Group Co., Ltd., Beijing (CN)

(21) Appl. No.: 14/094,011

(22) Filed: Dec. 2, 2013

(30) Foreign Application Priority Data
Dec. 12, 2012 (CN) 201210535755.2

(51) Int. Cl. G02F 1/155; C25D 9/02; C25D 15/00

(52) U.S. Cl. CPC G02F 1/155; C25D 15/00; C25D 9/02
USPC 359/265; 205/109

(57) ABSTRACT

A manufacturing method of an electrochromic working electrode is disclosed, comprising electroplating a first conductive polymer and nanoparticles in order on a surface of an ITO conductive glass using an electrochemical method so as to obtain a electrochromic working electrode coated with the first conductive polymer and the nanoparticles. The invention further discloses an electrochromic device. By adopting the invention, the reaction rate of an electrochromic material on a surface of the electrochromic working electrode can be improved, and the response time of the electrochromic material can be reduced.

### FIELD OF THE INVENTION

The invention relates to an electrochromic working electrode, in particular, to a manufacturing method of an electrochromic working electrode, and an electrochromic device.

### BACKGROUND OF THE INVENTION

The electrochromism refers to the phenomenon that stable, reversible changes of the optical properties (e.g. reflectivity, transmittance, absorptivity, etc.) of a material occur under the influence of an external electric field. In appearance, the phenomenon is represented as the reversible changes of color and transparency. Materials having the electrochromic property are known as the electrochromic materials, and devices made of an electrochromic material are known as the electrochromic devices. The working electrode in a conventional electrochromic device is a plane electrode, and such a plane electrode is relatively widely used in the field of electrochromism. However, the electrochromic material exhibits a lower reaction rate and a longer response time when a plane electrode is used.

### SUMMARY OF THE INVENTION

In view of the above, the main object of the invention is to provide a manufacturing method of an electrochromic working electrode and an electrochromic device, which can improve the reaction rate of the electrochromic material on a surface of the electrochromic working electrode and reduce the response time of the electrochromic material.

In order to achieve the above object, the technical solution of the present invention is realized by following manner.

In an embodiment, the present invention provides a manufacturing method of an electrochromic working electrode comprising electroplating a first conductive polymer and nanoparticles in order on a surface of an ITO conductive glass using an electrochemical method so as to obtain an electrochromic working electrode coated with the first conductive polymer and the nanoparticles.

Herein the nanoparticles are gold particles, silver particles, or particles of a second conductive polymer;

the second conductive polymer and the first conductive polymer are not the same conductive polymer;

the second conductive polymer include polypyrrole or polythiophene;

the size of the nanoparticles is within a range from 3 nm to 100 nm;

the first conductive polymer include polyaniline, polypyrrole or polythiophene.

Herein said electroplating a first conductive polymer and nanoparticles in order on a surface of an ITO conductive glass using an electrochemical method specifically includes:

placing an ITO conductive glass and an auxiliary electrode into a first solution to perform a first electropolymerization so as to produce an ITO conductive glass coated with a first conductive polymer; or placing an ITO conductive glass, an auxiliary electrode and a reference electrode into a first solution to perform a first electropolymerization so as to produce an ITO conductive glass coated with a first conductive polymer;

placing the ITO conductive glass coated with the first conductive polymer and an auxiliary electrode into a second solution to perform a second electropolymerization so as to produce an electrochromic working electrode coated with the first conductive polymer and the nanoparticles; or placing the ITO conductive glass coated with the first conductive polymer, an auxiliary electrode and a reference electrode into a second solution to perform a second electropolymerization so as to produce an electrochromic working electrode coated with the first conductive polymer and the nanoparticles;

wherein the first solution is a mixed solution of a monomer for the first conductive polymer and an acid solution;

the second solution includes a gold colloidal solution, a silver colloidal solution or a solution of a monomer for the second conductive polymer;

the solution of the monomer for the second conductive polymer is a mixed solution of the monomer for the second conductive polymer and an acid solution.

Herein the monomer for the first conductive polymer includes aniline, pyrrole or thiophene;

the monomer for the second conductive polymer include pyrrole or thiophene;

the addition amounts of the monomer for the first conductive polymer and the monomer for the second conductive polymer are within a range from 0.5 μl to 5 ml;

the acid solution is a sulfuric acid solution, a hydrochloric acid solution or a nitric acid solution;

the concentration of the acid solution is within a range from 0.5 mol/L to 5 mol/L;

the concentration of the gold colloidal solution is within a range from 0.05 mol/L to 5 mol/L;

the concentration of the silver colloidal solution is within a range from 0.05 mol/L to 5 mol/L;

the auxiliary electrode include a platinum electrode, a silver electrode; and the reference electrode is a saturated calomel electrode;

both of the first electropolymerization and the second electropolymerization are a chronoamperometry electropolymerization, a pulsed amperometry electropolymerization or a chronopotentiometry electropolymerization;

the chronoamperometry electropolymerization is carried out under conditions of a current density within a range from 0.5 m A/cm² to 50 mA/cm² and an electropolymerization time within a range from is to 500 s;

the pulsed amperometry electropolymerization is carried out under conditions of a pulse on/off ratio of (120 ms˜50 ms):(50 ms˜10 ms) and a frequency within a range from 30 Hz to 100 Hz;

the chronopotentiometry electropolymerization is carried out under conditions of a voltage within a range from 1V to 15 V and an electropolymerization time within a range from is to 500 s.

In an embodiment, the present invention further provides an electrochromic device, and the anode electrode in the electrochromic device is a working electrode coated with a first conductive polymer and nanoparticles produced by the manufacturing method mentioned above.

The manufacturing method of an electrochromic working electrode and the electrochromic device provided by embodiments of the present invention has the following advantages and characters.

By modifying an electrochromic working electrode with a conductive polymer and nanoparticles, the specific surface area of the electrochromic working electrode can be greatly improved, which allows the specific surface area can be up to hundreds or even tens of thousands times of the actual area of the electrochromic working electrode, so that the reaction rate of the electrochromic material on a surface of the electrochromic working electrode coated with conductive polymer and nanoparticles can be improved, and the response time of the electrochromic material can be reduced.

### BRIEF DESCRIPTION OF THE DRAWINGS

FIG. 1 is a side view of the structure of the working electrode coated with a conductive polymer and nanoparticles according to the invention;

FIG. 2 is a top view of the structure of the working electrode coated with a conductive polymer and nanoparticles according to the invention;

FIG. 3 is a schematic view of the experimental apparatus of the manufacturing method of the invention;

FIG. 4 is a photograph from transmission electron microscope of the gold nanoparticles in Example 2;

FIG. 5 is a photograph from transmission electron microscope of the conductive polymer and the gold nanoparticles in Example 9;

FIG. 6 is a schematic view of the configuration of the electrochromic device prepared by using the electrochromic working electrode of the invention;

FIG. 7 is a schematic view of the working principle of the electrochromic device prepared by using the electrochromic working electrode of the invention.

### DESCRIPTION OF THE REFERENCE SIGN

1. ITO conductive glass,
2. polyaniline layer,
3. gold nanoparticles,
4. cathode,
5. electrolyte,
6. electrochromic layer,
7. auxiliary electrode in the electrochromic device,
8. upper glass plate,
9. lower glass plate.

### DETAILED DESCRIPTION OF THE INVENTION

### Example 1

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method specifically included:

Step 1: mixing 2 μl aniline with a nitric acid solution having a concentration of 0.5 mol·L⁻¹ under magnetic stirring to prepare an aniline-nitric acid solution dispersed uniformly;

Step 2: placing an ITO conductive glass and a platinum electrode into the aniline-nitric acid solution dispersed uniformly, and performing a first electropolymerization by using chronoamperometry electropolymerization, wherein the current density was 0.5 mA/cm² and the electropolymerization time was 50 s, so as to produce an ITO conductive glass coated with polyaniline;

Step 3: placing the ITO conductive glass coated with polyaniline and a platinum electrode into a gold colloidal solution having a concentration of 0.5 mol/L, and performing a second electropolymerization by using chronoamperometry electropolymerization, wherein the current density was 0.5 mA/cm² and the electropolymerization time was 10 s, so as to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode.

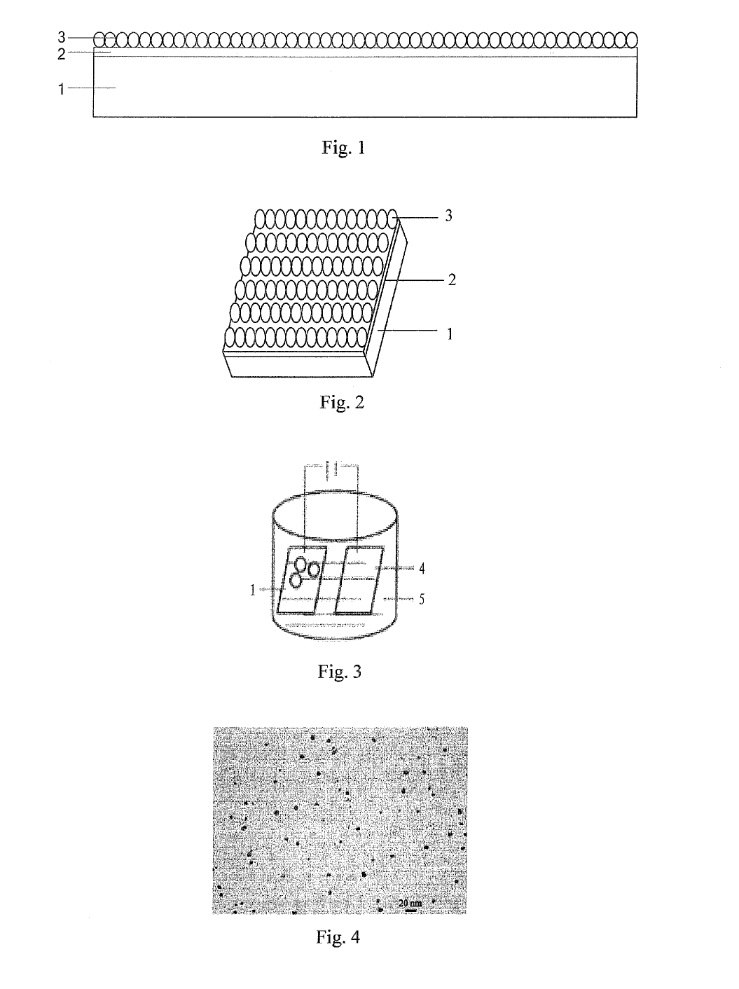

FIG. 1 is a side view of the structure of the electrochromic working electrode of the invention; FIG. 2 is a top view of the structure of the electrochromic working electrode of the invention. As shown in FIG. 1 and FIG. 2, 1 indicates an ITO conductive glass, 2 indicates a polyaniline layer, and 3 indicates gold nanoparticles. From the figures it can be seen, that the surface of the ITO conductive glass is coated with polyaniline and gold nanoparticles in order. It should be noticed here that when the nanoparticles are polyaniline particles, the nanoparticle layers indicated by 3 in FIG. 1 and FIG. 2 are not limited by such a particulate shape, but also can be in a shape of fibers.

FIG. 3 is a schematic drawing of the experimental apparatus of the manufacturing method of the invention. From FIG. 3 it can be seen, that 1 is the ITO conductive glass as the anode, 4 is a platinum electrode as the cathode, and polyaniline and nanoparticles are deposited in order on the ITO conductive glass by electrochemical method.

### Example 2

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method specifically included:

Step 1: mixing 1 ml aniline with a nitric acid solution having a concentration of 0.5 mol·L⁻¹ under magnetic stirring to prepare an aniline-nitric acid solution dispersed uniformly;

Step 2: placing an ITO conductive glass, a platinum electrode and a saturated calomel electrode into the aniline-nitric acid solution dispersed uniformly, performing a first electropolymerization by using chronoamperometry electropolymerization, wherein the current density was 0.5 mA/cm² and the electropolymerization time was 50 s, so as to produce an ITO conductive glass coated with polyaniline;

Step 3: placing the ITO conductive glass coated with polyaniline, a platinum electrode and a saturated calomel electrode into a gold colloidal solution having a concentration of 0.5 mol/L, and performing a second electropolymerization by using chronoamperometry electropolymerization, wherein the current density was 0.5 mA/cm² and the electropolymerization time was 10 s, so as to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

FIG. 4 is the TEM photograph of the gold nanoparticles in Example 2. As shown in FIG. 4, the size of the gold nanoparticle is about 5 nm.

### Example 3

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 5 ml aniline with a nitric acid solution having a concentration of 0.5 mol·L⁻¹ under magnetic stirring to prepare an aniline-nitric acid solution dispersed uniformly;

Step 2: placing an ITO conductive glass, a platinum electrode and a saturated calomel electrode into the aniline-nitric acid solution dispersed uniformly, performing a first electropolymerization by using chronoamperometry electropolymerization, wherein the current density was 0.5 mA/cm² and the electropolymerization time was 50 s, so as to produce an ITO conductive glass coated with polyaniline;

Step 3: placing the ITO conductive glass coated with polyaniline, a platinum electrode and a saturated calomel electrode into a gold colloidal solution having a concentration of 0.5 mol/L, and performing a second electropolymerization by using chronoamperometry electropolymerization, wherein the current density was 0.5 mA/cm² and the electropolymerization time was 10 s, so as to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 4

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 5 ml aniline with a nitric acid solution having a concentration of 2.5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, performing a first electropolymerization by using chronoamperometry electropolymerization, wherein the current density was 0.5 mA/cm² and the electropolymerization time was 50 s, to produce an ITO conductive glass coated with polyaniline;

Step 3: placing the ITO conductive glass coated with polyaniline, a platinum electrode and a saturated calomel electrode in a gold colloidal solution having a concentration of 0.5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 5

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 5 ml aniline with a nitric acid solution having a concentration of 5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, performing a first electropolymerization by using chronoamperometry electropolymerization, wherein the current density was 0.5 mA/cm² and the electropolymerization time was 50 s, to produce an ITO conductive glass coated with polyaniline;

Step 3: placing the ITO conductive glass coated with polyaniline, a platinum electrode and a saturated calomel electrode in a gold colloidal solution having a concentration of 0.5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 6

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, performing a first electropolymerization by using chronoamperometry electropolymerization, wherein the current density was 0.5 mA/cm² and the electropolymerization time was 50 s, to produce an ITO conductive glass coated with polyaniline;

Step 3: placing the ITO conductive glass coated with polyaniline, a platinum electrode and a saturated calomel electrode in a gold colloidal solution having a concentration of 0.5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 7

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, performing a first electropolymerization by using chronoamperometry electropolymerization, wherein the current density was 0.5 mA/cm² and the electropolymerization time was 500 s, to produce an ITO conductive glass coated with polyaniline;

Step 3: placing the ITO conductive glass coated with polyaniline and a platinum electrode in a gold colloidal solution having a concentration of 0.5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode.

### Example 8

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, performing a first electropolymerization by using chronoamperometry electropolymerization, wherein the current density was 0.5 mA/cm² and the electropolymerization time was 50 s, to produce an ITO conductive glass coated with polyaniline;

Step 3: placing the ITO conductive glass coated with polyaniline and a platinum electrode in a gold colloidal solution having a concentration of 5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode.

### Example 9

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using pulsed amperometry electropolymerization, wherein the pulse on/off ratio tₒₙ:t_{off}=50 ms:10 ms, the frequency was 100 Hz and the electropolymerization time was 100 s, to produce an ITO conductive glass coated with polyaniline;

Step 3: placing the ITO conductive glass coated with polyaniline and a platinum electrode in a gold colloidal solution having a concentration of 2.5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode.

FIG. 5 is the TEM photograph of the conductive polymer and the gold nanoparticles in Example 9. As shown in FIG. 5, the size of the gold nanoparticle is about 3 nm

### Example 10

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, and performing a first electropolymerization by using chronopotentiometry electropolymerization, wherein the voltage was 1 V and the electropolymerization time was 50 s, to produce an ITO conductive glass coated with polyaniline;

Step 3: placing the ITO conductive glass coated with polyaniline, a platinum electrode and a saturated calomel electrode in a gold colloidal solution having a concentration of 2.5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 11

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, and performing a first electropolymerization by using chronopotentiometry electropolymerization, wherein the voltage was 5 V and the electropolymerization time was 50 s, to produce an ITO conductive glass coated with polyaniline;

Step 3: placing the ITO conductive glass coated with polyaniline, a platinum electrode and a saturated calomel electrode in a gold colloidal solution having a concentration of 2.5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 12

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, and performing a first electropolymerization by using chronopotentiometry electropolymerization, wherein the voltage was 15 V and the electropolymerization time was 50 s, to produce an ITO conductive glass coated with polyaniline;

Step 3: placing the ITO conductive glass coated with polyaniline, a platinum electrode and a saturated calomel electrode in a gold colloidal solution having a concentration of 2.5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 13

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, and performing a first electropolymerization by using chronopotentiometry electropolymerization, wherein the voltage was 15 V and the electropolymerization time was 50 s, to produce an ITO conductive glass coated with polyaniline;

Step 3: placing the ITO conductive glass coated with polyaniline, a platinum electrode and a saturated calomel electrode in a gold colloidal solution having a concentration of 2.5 mol/L, and performing a second electropolymerization by using chronoamperometry electropolymerization, wherein the current density was 50 mA/cm² and the electropolymerization time was 1 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 14

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, and performing a first electropolymerization by using chronopotentiometry electropolymerization, wherein the voltage was 15 V and the electropolymerization time was 50 s, to produce an ITO conductive glass coated with polyaniline;

Step 3: placing the ITO conductive glass coated with polyaniline, a platinum electrode and a saturated calomel electrode in a gold colloidal solution having a concentration of 2.5 mol/L, and performing a second electropolymerization by using chronoamperometry electropolymerization, wherein the current density was 50 mA/cm² and the electropolymerization time was 500 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 15

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using chronopotentiometry electropolymerization, wherein the voltage was 15 V and the electropolymerization time was 50 s, to produce an ITO conductive glass coated with polyaniline;

Step 3: placing the ITO conductive glass coated with polyaniline and a platinum electrode in a gold colloidal solution having a concentration of 0.5 mol/L, and performing a second electropolymerization by using chronoamperometry electropolymerization, wherein the current density was 50 mA/cm² and the electropolymerization time was 500 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, the size of the gold nanoparticle was about 100 nm

### Example 16

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using chronopotentiometry electropolymerization, wherein the voltage was 15 V and the electropolymerization time was 50 s, to produce an ITO conductive glass coated with polyaniline;

Step 3: placing the ITO conductive glass coated with polyaniline and a platinum electrode in a gold colloidal solution having a concentration of 2.5 mol/L, and performing a second electropolymerization by using chronoamperometry electropolymerization, wherein the current density was 25 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, the size of the gold nanoparticle was about 20 nm

### Example 17

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using chronopotentiometry electropolymerization, wherein the voltage was 15 V and the electropolymerization time was 50 s, to produce an ITO conductive glass coated with polyaniline;

Step 3: placing the ITO conductive glass coated with polyaniline and a platinum electrode in a gold colloidal solution having a concentration of 2.5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, the size of the gold nanoparticle was about 5 nm

### Example 18

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using pulsed amperometry electropolymerization, wherein the pulse on/off ratio tₒₙ:t_{off} was 120 ms:50 ms, the frequency was 100 Hz and the electropolymerization time was 100 s, to produce an ITO conductive glass coated with polyaniline;

Step 3: placing the ITO conductive glass coated with polyaniline and a platinum electrode in a gold colloidal solution having a concentration of 2.5 mol/L, and performing a second electropolymerization by using chronoamperometry electropolymerization, wherein the current density was 0.5 mA/cm² and the electropolymerization time was 200 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, the size of the gold nanoparticle was about 100 nm

### Example 19

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using pulsed amperometry electropolymerization, wherein the pulse on/off ratio tₒₙ:t_{off} was 90 ms:20 ms, the frequency was 100 Hz and the electropolymerization time was 100 s, to produce an ITO conductive glass coated with polyaniline;

Step 3: placing the ITO conductive glass coated with polyaniline and a platinum electrode in a gold colloidal solution having a concentration of 2.5 mol/L, and performing a second electropolymerization by using chronoamperometry electropolymerization, wherein the current density was 0.5 mA/cm² and the electropolymerization time was 120 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, the size of the gold nanoparticle was about 50 nm.

### Example 20

Aniline was used as the monomer for the first conductive polymer and a nitric acid solution was used as the acid solution, and thus the first solution was an aniline-nitric acid solution. Pyrrole was used as the monomer for the second conductive polymer and a nitric acid solution was used as the acid solution, and thus the second solution was the pyrrole-nitric acid solution. An electrochromic working electrode coated with polyaniline and polypyrrole particles was produced, wherein polyaniline was used as the first conductive polymer and polypyrrole was used as the second conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using pulsed amperometry electropolymerization, wherein the pulse on/off ratio tₒₙ:t_{off} was 90 ms:20 ms, the frequency was 100 Hz and the electropolymerization time was 100 s, to produce an ITO conductive glass coated with polyaniline;

Step 3: mixing 1 ml pyrrole with a nitric acid solution having a concentration of 5 mol·L⁻¹ under magnetic stirring to prepare a pyrrole-nitric acid solution dispersed uniformly;

Step 4: placing the ITO conductive glass coated with polyaniline and a platinum electrode in the pyrrole-nitric acid solution, and performing a second electropolymerization by using chronoamperometry electropolymerization, wherein the current density was 0.5 mA/cm² and the electropolymerization time was 120 s, to produce an electrochromic working electrode coated with polyaniline and polypyrrole particles;

wherein the ITO conductive glass and the ITO conductive glass coated with polyaniline were anode electrode, and the platinum electrode was an auxiliary electrode, i.e. the cathode electrode.

### Example 21

Aniline was used as the monomer for the first conductive polymer and a nitric acid solution was used as the acid solution, and thus the first solution was an aniline-nitric acid solution. Thiophene was used as the monomer for the second conductive polymer and a nitric acid solution was used as the acid solution, and thus the second solution was the thiophene-nitric acid solution. An electrochromic working electrode coated with polyaniline and polythiophene particles was produced, wherein polyaniline was used as the first conductive polymer and polythiophene was used as the second conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using pulsed amperometry electropolymerization, wherein the pulse on/off ratio tₒₙ:t_{off}=90 ms:20 ms, the frequency was 100 Hz and the electropolymerization time was 100 s, to produce an ITO conductive glass coated with polyaniline;

Step 3: mixing 1 ml thiophene with a nitric acid solution having a concentration of 5 mol·L⁻¹ under magnetic stirring to prepare a thiophene-nitric acid solution dispersed uniformly;

Step 4: placing the ITO conductive glass coated with polyaniline and a platinum electrode in the thiophene solution, and performing a second electropolymerization by using chronoamperometry electropolymerization, wherein the current density was 0.5 mA/cm² and the electropolymerization time was 120 s, to produce an electrochromic working electrode coated with polyaniline and polythiophene particles;

wherein the ITO conductive glass and the ITO conductive glass coated with polyaniline were anode electrode, and the platinum electrode was an auxiliary electrode, i.e. the cathode electrode.

### Example 22

Pyrrole was used as the monomer for the first conductive polymer and a sulfuric acid solution was used as the acid solution, and thus the first solution was a pyrrole-sulfuric acid solution. A silver colloidal solution was used as the second solution. An electrochromic working electrode coated with polypyrrole and silver nanoparticles was produced, wherein polypyrrole was used as the first conductive polymer, and the manufacturing method particularly included:

Step 1: mixing 0.5 μl pyrrole with a sulfuric acid solution having a concentration of 5 mol·L⁻¹ under magnetic stirring to prepare a pyrrole-sulfuric acid solution dispersed uniformly;

Step 2: placing the ITO conductive glass and a platinum electrode in the pyrrole-sulfuric acid solution dispersed uniformly, and performing a first electropolymerization by using pulsed amperometry electropolymerization, wherein the pulse on/off ratio tₒₙ:t_{off} was 90 ms:20 ms, the frequency was 100 Hz and the electropolymerization time was 100 s, to produce an ITO conductive glass coated with polypyrrole;

Step 3: placing the ITO conductive glass coated with polypyrrole, a platinum electrode and a saturated calomel electrode in a silver colloidal solution having a concentration of 2.9 mol/L, and performing a second electropolymerization by using chronoamperometry electropolymerization, wherein the current density was 50 mA/cm² and the electropolymerization time was 1 s, to produce an electrochromic working electrode coated with polypyrrole and silver nanoparticles;

wherein the ITO conductive glass and the ITO conductive glass coated with polypyrrole were anode electrode, and the platinum electrode was an auxiliary electrode, i.e. the cathode electrode, and the saturated calomel electrode was a reference electrode.

### Example 23

Thiophene was used as the monomer for the first conductive polymer and a hydrochloric acid solution was used as the acid solution, and thus the first solution was an thiophene-hydrochloric acid solution. A silver colloidal solution was used as the second solution. An electrochromic working electrode coated with polythiophene and silver nanoparticles was produced, wherein polythiophene was used as the first conductive polymer, and the manufacturing method particularly included:

Step 1: mixing 0.9 μl thiophene with a hydrochloric acid solution having a concentration of 5 mol·L⁻¹ under magnetic stirring to prepare a thiophene-hydrochloric acid solution dispersed uniformly;

Step 2: placing the ITO conductive glass, a platinum electrode and a saturated calomel electrode in the thiophene-hydrochloric acid solution dispersed uniformly, and performing a first electropolymerization by using pulsed amperometry electropolymerization, wherein the pulse on/off ratio tₒₙ:t_{off} was 90 ms:20 ms, the frequency was 100 Hz and the electropolymerization time was 100 s, to produce an ITO conductive glass coated with polythiophene;

Step 3: placing the ITO conductive glass coated with polythiophene, a platinum electrode and a saturated calomel electrode in a silver colloidal solution having a concentration of 5 mol/L, and performing a second electropolymerization by using chronoamperometry electropolymerization, wherein the current density was 35 mA/cm² and the electropolymerization time was 450 s, to produce an electrochromic working electrode coated with polythiophene and silver nanoparticles;

wherein the ITO conductive glass and the ITO conductive glass coated with polythiophene was an anode electrode, and the platinum electrode was an auxiliary electrode, i.e. the cathode electrode, and the saturated calomel electrode was a reference electrode.

### Example 24

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, and performing a first electropolymerization by using chronopotentiometry electropolymerization, wherein the voltage was 15 V and the electropolymerization time was 1 s, to produce an ITO conductive glass coated with polyaniline;

Step 3: placing the ITO conductive glass coated with polyaniline, a platinum electrode and a saturated calomel electrode in a gold colloidal solution having a concentration of 5 mol/L, and performing a second electropolymerization by using chronoamperometry electropolymerization, wherein the current density was 50 mA/cm² and the electropolymerization time was 500 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 25

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 1 ml aniline with a nitric acid solution having a concentration of 4.5 mol·L⁻¹ under magnetic stirring to prepare an aniline-nitric acid solution dispersed uniformly;

Step 2: placing an ITO conductive glass, a silver electrode and a saturated calomel electrode in the aniline-nitric acid solution dispersed uniformly, and performing a first electropolymerization by using chronopotentiometry electropolymerization, wherein the voltage was 5 V and the electropolymerization time was 50 s, to produce an ITO conductive glass coated with polyaniline;

Step 3: placing the ITO conductive glass coated with polyaniline, a silver electrode and a saturated calomel electrode in the gold colloidal solution having a concentration of 0.05 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the silver electrode was an auxiliary electrode, i.e. the cathode electrode, and the saturated calomel electrode was a reference electrode.

### Example 26

Aniline was used as the monomer for the first conductive polymer and a nitric acid solution was used as the acid solution, and thus the first solution was an aniline-nitric acid solution. A silver colloidal solution was used as the second solution. An electrochromic working electrode coated with polyaniline and silver nanoparticles was produced, wherein polyaniline was used as the first conductive polymer, and the manufacturing method particularly included:

Step 1: mixing 5 ml aniline with a nitric acid solution having a concentration of 5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, performing a first electropolymerization by using chronoamperometry electropolymerization, wherein the current density was 50 mA/cm² and the electropolymerization time was 1 s, to produce an ITO conductive glass coated with polyaniline;

Step 3: placing the ITO conductive glass coated with polyaniline, a platinum electrode and a saturated calomel electrode in a silver colloidal solution having a concentration of 0.05 mol/L, and performing a second electropolymerization by using chronoamperometry electropolymerization, wherein the current density was 0.5 mA/cm² and the electropolymerization time was 10 s, to produce an electrochromic working electrode coated with polyaniline and silver nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 27

Aniline was used as the monomer for the first conductive polymer and a nitric acid solution was used as the acid solution, and thus the first solution was an aniline-nitric acid solution. Thiophene was used as the monomer for the second conductive polymer and hydrochloric acid solution was used as acid solution, and thus the second solution was a thiophene-hydrochloric acid solution. An electrochromic working electrode coated with polyaniline and polythiophene particles was produced, wherein polyaniline was used as the first conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using pulsed amperometry electropolymerization, wherein the pulse on/off ratio tₒₙ:t_{off}=90 ms:20 ms, the frequency was 30 Hz and the electropolymerization time was 100 s, to produce an ITO conductive glass coated with polyaniline;

Step 3: mixing 0.5 μl thiophene with a hydrochloric acid solution having a concentration of 0.5 mol·L⁻¹ under magnetic stirring to prepare a thiophene-hydrochloric acid solution dispersed uniformly;

Step 4: placing the ITO conductive glass coated with polyaniline, a saturated calomel electrode and a platinum electrode in the thiophene-hydrochloric acid solution, and performing a second electropolymerization by using chronoamperometry electropolymerization, wherein the current density was 0.5 mA/cm² and the electropolymerization time was 120 s, to produce an electrochromic working electrode coated with polyaniline and polythiophene particles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

### Example 28

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 3 ml aniline with a nitric acid solution having a concentration of 3.5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using pulsed amperometry electropolymerization, wherein the pulse on/off ratio tₒₙ:t_{off}=100 ms:30 ms, the frequency was 60 Hz and the electropolymerization time was 100 s, to produce an ITO conductive glass coated with polyaniline;

Step 3: placing the ITO conductive glass coated with polyaniline, a saturated calomel electrode and a silver electrode in a gold colloidal solution having a concentration of 2.5 mol/L, and performing a second electropolymerization by using chronoamperometry electropolymerization, wherein the current density was 0.5 mA/cm² and the electropolymerization time was 10 s, to produce an electrochromic working electrode coated with polyaniline and gold nanoparticles;

wherein the ITO conductive glass and the ITO conductive glass coated with polyaniline were anode electrode, and the silver electrode was an auxiliary electrode, i.e. the cathode electrode, and the saturated calomel electrode was a reference electrode.

### Example 29

Aniline was used as the monomer for the first conductive polymer and a nitric acid solution was used as the acid solution, and thus the first solution was an aniline-nitric acid solution. Pyrrole was used as the monomer for the second conductive polymer and a nitric acid solution was used as the acid solution, and thus the second solution was the pyrrole-nitric acid solution. An electrochromic working electrode coated with polyaniline and polypyrrole particles was produced, wherein polyaniline was used as the first conductive polymer and polypyrrole was used as the second conductive polymer, and the manufacturing method particularly included:

Step 1: mixing 1 ml aniline with a nitric acid solution having a concentration of 5 mol·L⁻¹ under magnetic stirring to prepare an aniline-nitric acid solution dispersed uniformly;

Step 2: placing an ITO conductive glass and a platinum electrode in the aniline-nitric acid solution dispersed uniformly, and performing a first electropolymerization by using pulsed amperometry electropolymerization, wherein the pulse on/off ratio tₒₙ:t_{off} was 90 ms:20 ms, the frequency was 100 Hz and the electropolymerization time was 80 s, to produce an ITO conductive glass coated with polyaniline;

Step 3: mixing 5 ml pyrrole with a nitric acid solution having a concentration of 3.5 mol·L⁻¹ under magnetic stirring to prepare a pyrrole-nitric acid solution dispersed uniformly;

Step 4: placing the ITO conductive glass coated with polyaniline and a platinum electrode in the pyrrole-nitric acid solution, performing the second electropolymerization by using chronopotentiometry electropolymerization, wherein the voltage was 2 V and the electropolymerization time was 500 s, to produce an electrochromic working electrode coated with polyaniline and polypyrrole particles;

wherein the ITO conductive glass and the ITO conductive glass coated with polyaniline were anode electrode, and the platinum electrode was an auxiliary electrode, i.e. the cathode electrode.

### Example 30

Pyrrole was used as the monomer for the first conductive polymer and a sulfuric acid solution was used as the acid solution, and thus the first solution was the pyrrole-sulfuric acid solution. A silver colloidal solution was used as the second solution. An electrochromic working electrode coated with polypyrrole and silver nanoparticles was produced, wherein polypyrrole was used as the first conductive polymer, and the manufacturing method particularly included:

Step 1: mixing 0.5 μl pyrrole with a sulfuric acid solution having a concentration of 5 mol·L¹ under magnetic stirring to prepare pyrrole-sulfuric acid solution dispersed uniformly;

Step 2: placing an ITO conductive glass and a platinum electrode in the pyrrole-sulfuric acid solution dispersed uniformly, and performing a first electropolymerization by using pulsed amperometry electropolymerization, wherein the pulse on/off ratio tₒₙ:t_{off} was 90 ms:20 ms, the frequency was 100 Hz and the electropolymerization time was 100 s, to produce an ITO conductive glass coated with polypyrrole;

Step 3: placing the ITO conductive glass coated with polypyrrole, a saturated calomel electrode and a platinum electrode in a silver colloidal solution having a concentration of 2.9 mol/L, and performing a second electropolymerization by using chronoamperometry electropolymerization, wherein the current density was 50 mA/cm² and the electropolymerization time was 1 s, to produce an electrochromic working electrode coated with polypyrrole and silver nanoparticles;

wherein the ITO conductive glass and the ITO conductive glass coated with polypyrrole were anode electrode, and the platinum electrode was an auxiliary electrode, i.e. the cathode electrode, and the saturated calomel electrode was a reference electrode.

### Example 31

Aniline was used as the monomer for the first conductive polymer and a nitric acid solution was used as the acid solution, and thus the first solution was an aniline-nitric acid solution. A gold colloidal solution was used as the second solution. An electrochromic working electrode coated with polyaniline and gold nanoparticles was produced, wherein polyaniline was used as the first conductive polymer, and the manufacturing method particularly included:

Step 1: mixing 5 ml aniline with a nitric acid solution having a concentration of 0.5 mol·L⁻¹ under magnetic stirring to prepare an aniline-nitric acid solution dispersed uniformly;

Step 2: placing an ITO conductive glass, a platinum electrode and a saturated calomel electrode in the aniline-nitric acid solution dispersed uniformly, and performing a first electropolymerization by using chronopotentiometry electropolymerization, wherein the voltage was 5 V and the electropolymerization time was 500 s, to produce an ITO conductive glass coated with polyaniline;

Step 3: placing the ITO conductive glass coated with polyaniline, a platinum electrode and a saturated calomel electrode in a gold colloidal solution having a concentration of 0.5 mol/L, and performing a second electropolymerization by using pulsed amperometry electropolymerization, wherein the pulse on/off ratio tₒₙ:t_{off} was 80 ms:25 ms, the frequency was 50 Hz and the electropolymerization time was 150 s, to produce an electrochromic working electrode coated with polyaniline and gold nanoparticles;

wherein the ITO conductive glass and the ITO conductive glass coated with polyaniline were anode electrode, and the platinum electrode was an auxiliary electrode, i.e. the cathode electrode, and the saturated calomel electrode was a reference electrode.

It should be noticed here, that with regard to the electrochromic working electrodes coated with the first conductive polymer and nanoparticles produced in the above examples, all the sizes of the nanoparticles are in the range of 3 nm to 100 nm. Furthermore, the electrochromic working electrodes coated with the first conductive polymer and nanoparticles produced in the above examples are mainly used as anode electrode in an electrochromic device.

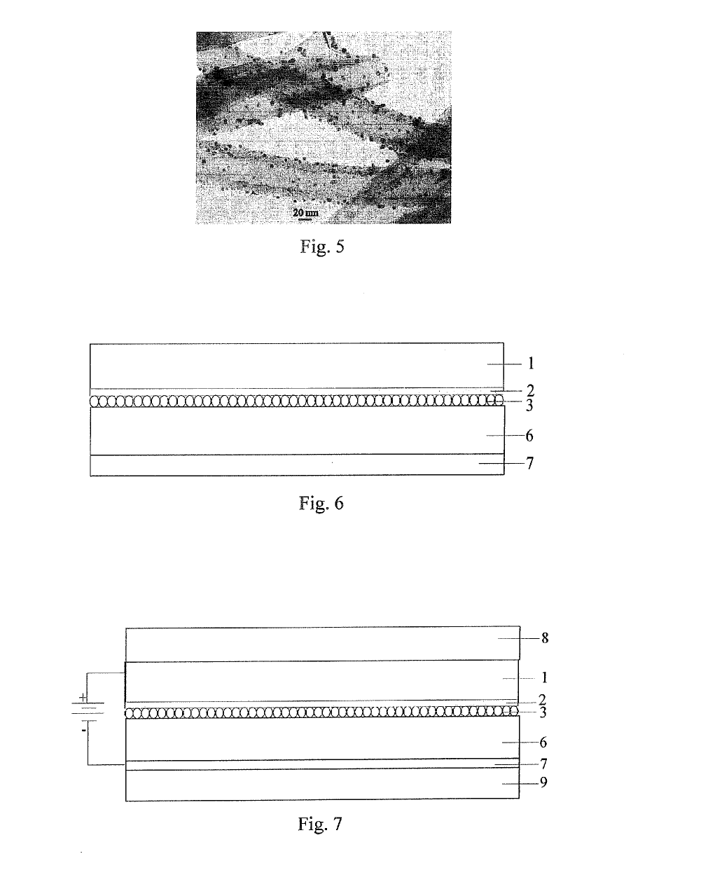

FIG. 6 is a schematic view of the configuration of the electrochromic device prepared by using the electrochromic working electrode of the invention; FIG. 7 is a schematic view of the working principle of the electrochromic device prepared by using the working electrode of the invention. By using the electrochromic devices produced by the electrochromic working electrode of the invention, the reaction rate of a electrochromic material on a surface of the electrochromic working electrode can be improved, and the response time of the electrochromic material can be reduced.

The Examples mentioned above are just preferred Examples and not for limiting the protection scope of the invention.

1. A manufacturing method of an electrochromic working electrode, comprising electroplating a first conductive polymer and nanoparticles in order on a surface of an ITO conductive glass using an electrochemical method so as to obtain an electrochromic working electrode coated with the first conductive polymer and the nanoparticles.

2. The manufacturing method according to claim 1, wherein the nanoparticles are gold particles, silver particles, or particles of a second conductive polymer.

3. The manufacturing method according to claim 2, wherein the second conductive polymer and the first conductive polymer are not the same conductive polymer.

4. The manufacturing method according to claim 2, wherein the second conductive polymer includes polypyrrole or polythiophene.

5. The manufacturing method according to claim 1, wherein the size of the nanoparticles is within a range from 3 nm to 100 nm.

6. The manufacturing method according to claim 1, wherein the first conductive polymer includes polyaniline, polypyrrole or polythiophene.

7. The manufacturing method according to claim 1, wherein said electroplating a first conductive polymer and nanoparticles in order on a surface of an ITO conductive glass using an electrochemical method specifically includes:
placing an ITO conductive glass and an auxiliary electrode into a first solution to perform a first electropolymerization so as to produce an ITO conductive glass coated with a first conductive polymer; or placing an ITO conductive glass, an auxiliary electrode and a reference electrode into a first solution to perform a first electropolymerization so as to produce an ITO conductive glass coated with a first conductive polymer;
placing the ITO conductive glass coated with the first conductive polymer and an auxiliary electrode into a second solution to perform a second electropolymerization so as to produce an electrochromic working electrode coated with the first conductive polymer and nanoparticles; or placing the ITO conductive glass coated with the first conductive polymer, an auxiliary electrode and a reference electrode into a second solution to perform a second electropolymerization so as to produce an electrochromic working electrode coated with the first conductive polymer and nanoparticles;
wherein the first solution is a mixed solution of a monomer for the first conductive polymer and an acid solution;
the second solution includes a gold colloidal solution, a silver colloidal solution or a solution of a monomer for the second conductive polymer;
the solution of the monomer for the second conductive polymer is a mixed solution of the monomer for the second conductive polymer and an acid solution.

8. The manufacturing method according to claim 7, wherein the monomer for the first conductive polymer include aniline, pyrrole or thiophene.

9. The manufacturing method according to claim 7, wherein the monomer for the second conductive polymer include pyrrole or thiophene.

10. The manufacturing method according to claim 7, wherein the addition amounts of the monomer for the first conductive polymer and the monomer for the second conductive polymer are within a range from 0.5 μl to 5 ml.

11. The manufacturing method according to claim 7, wherein the acid solution is: a sulfuric acid solution, a hydrochloric acid solution or a nitric acid solution.

12. The manufacturing method according to claim 7, wherein the concentration of the acid solution is within a range from 0.5 mol/L to 5 mol/L.

13. The manufacturing method according to claim 7, wherein the concentration of the gold colloidal solution is within a range from 0.05 mol/L to 5 mol/L.

14. The manufacturing method according to claim 7, wherein the concentration of the silver colloidal solution is within a range from 0.05 mol/L to 5 mol/L.

15. The manufacturing method according to claim 7, wherein the auxiliary electrode includes a platinum electrode, or a silver electrode; and the reference electrode is a saturated calomel electrode.

16. The manufacturing method according to claim 7, wherein both of the first electropolymerization and the second electropolymerization are a chronoamperometry electropolymerization, a pulsed amperometry electropolymerization or a chronopotentiometry electropolymerization.

17. The manufacturing method according to claim 16, wherein the chronoamperometry electropolymerization is carried out under conditions of a current density within a range from 0.5 m A/cm² to 50 mA/cm² and an electropolymerization time of within a range from is to 500 s.

18. The manufacturing method according to claim 16, wherein the pulsed amperometry electropolymerization is carried out under conditions of a pulse on/off ratio of (120 ms˜50 ms):(50 ms˜10 ms) and a frequency within a range from 30 Hz to 100 Hz.

19. The manufacturing method according to claim 16, wherein the chronopotentiometry electropolymerization is carried out under conditions of a voltage within a range from 1V to 15 V and an electropolymerization time within a range from is to 500 s.

20. An electrochromic device, wherein the anode electrode in the electrochromic device is a working electrode coated with a first conductive polymer and nanoparticles produced by the manufacturing method according to claim 1.
